(19) United States
(12) Patent Application Publication
(10) Pub. No.: US 2026/0174056 A1
(43) Pub. Date: Jun. 25, 2026

(54) MASTITIS SENSOR

(71) Applicant: KORU INNOVATIONS LIMITED, Hamilton (NZ)

(72) Inventors: Paul Trevor JOHNSTONE, Hamilton (NZ); Michael Bryan WILLIAMS, Hamilton (NZ)

(73) Assignee: KORU INNOVATIONS LIMITED, Hamilton (NZ)

(21) Appl. No.: 19/128,513

(22) PCT Filed: Nov. 10, 2023
(86) PCT No.: PCT/NZ2023/050127

§ 371 Date: May 8, 2025

(30) Foreign Application Priority Data
Nov. 11, 2022 (NZ) 794364

(51) Int. Cl. A01J 5/013; G01N 11/12

(52) U.S. Cl. CPC A01J 5/0136; G01N 11/12

(57) ABSTRACT

In one aspect the invention provides a portable hand held mastitis sensor with a testing chamber defining a receiving port, and a liquid reagent reservoir where a reagent delivery assembly is provided to deliver liquid reagent to the testing chamber. Also provides are a shuttle and a shuttle contact transducer engaged with the testing chamber opposite to the receiving port, as well as a shuttle position reset assembly, and an output indication assembly. Testing procedures are completed with the mastitis sensor by measuring the fall time of the shuttle through a testing chamber containing a mixture of milk and liquid reagent.

### FIELD OF THE INVENTION

This invention relates to a mastitis sensor. In various preferred embodiments the invention may provide a handheld, portable apparatus used to assess milk samples obtained from dairy animals.

### BACKGROUND OF THE INVENTION

The productive output of dairy animals can be impacted by mastitis, an infection of one or more udder sections. Dairy animals suffering from mastitis should have their milk output segregated for health and safety reasons. Animals identified with mastitis infections can also be selected for health treatments, or dried off and removed from the members of a dairy herd being milked.

It is important for dairy farmers to undertake tests to determine which of their animals are suffering from mastitis. Milk from an infected animal can be added to a gelling reagent, where the viscosity of the resulting mixture indicates the extent or degree of the mastitis infection experienced by the animal.

This approach is utilised by the California mastitis test (CMT), a manual process completed using milk samples collected from a specific animal. A milk sample is manually stripped from an udder quarter or half depending on the animal species, a reagent is added to the milk, and the mixture is manually agitated or stirred for a short time. A visual assessment is then made of the approximate viscosity of the resulting mixture, with the results of the CMT process indicating one of four states of mastitis infection.

This manual testing process is relatively slow, and the results obtained are highly variable depending on the technique of the person completing the test. The results available are of relatively low resolution, only being capable of indicating whether an animal has no indication of mastitis, a trace level of infection, a greater than trace level of infection or a significant infection.

Attempts to automate and improve on the above manual testing process have been developed with specific implementations focused on robotic milking assemblies. In particular, U.S. Pat. No. 7,234,414 provides an example of such an automated system which is permanently installed with a connection to a milk collection line of a dairy facility.

This assembly receives a sample of milk extracted from a collection line engaged with a single dairy animal. The milk sample is pumped to a mixing chamber and mixed with a reagent, then pumped to a testing chamber were a ball or shuttle is deployed to fall through the mixture under the influence of gravity. The fall time of the ball or shuttle is measured to indicate the viscosity of the combined milk and reagent mixture.

Another example of a similar automated sensing system is disclosed in U.S. Pat. No. 8,739,608. This document discloses an embodiment where a free-falling shuttle element travels vertically through a milk/reagent mixture. Fall time is again measured to indicate viscosity and hence the extent of any mastitis infection in the milk sample. The shuttle incorporates a magnet, and an electromagnetic coil is used to maneuverer the shuttle to an initial starting position, where a signal induced in the coil by the fall of the shuttle is used to derive a measured fall time. Embodiments of this system are also described where the shuttle is formed with stabilising fins or projections to induce a controlled predictable falling motion.

These types of mastitis sensors are relatively complicated systems. Electrical pumps are used to supply and mix milk and liquid reagent within the various chambers of the assembly, with a connection to mains electricity being required to power the operation of the system. Each automated sensing assembly is also deployed at a single animal milking site or bail only, meaning that multiple assemblies are required when multiple dairy animals are to be milked at the same time. This can result in a relatively high installation cost, particularly when the automated electrical components of the assembly are taken into account.

The automated components used also create a maintenance issue. Care needs to be taken to ensure that the parts of the assembly are cleaned effectively, that they operate properly, and that they do not create a source of contamination or infection. Maintenance operations can also be quite involved, potentially requiring the disassembly of the sensor itself and its connection to a dairy facility collection line.

These prior art systems and in particular the system described in U.S. Pat. No. 8,739,608 had difficulty providing accurate results in the case of both trace and extreme mastitis infections. In particular when magnetically induced electrical signals are used to determine shuttle fall times, the variations in the waveforms being worked with can be difficult to interpret accurately.

The cleaning of parts that have been in contact with raw milk is also problematic for automated systems. Raw milk contains fats and proteins which adhere to surfaces and can build up over time. Combined milk and reagent mixtures can become very viscous and stringy, especially for high mastitis samples and this can cause clogging of internal parts. If power to a prior art sensor is interrupted during normal processes when milk is being processed, milk can congeal in a short space of time. This results in a solid mass which cannot be removed automatically, and in these cases the prior art sensor must be open carefully and if possible, the soiled internal surfaces must be manually cleaned.

It would be of advantage to have improvements in the field of mastitis sensors which addressed any or all of the above problems or at least provided the public with an alternative choice. In particular, it would be of advantage to have a handheld automated or semi-automated mastitis sensor which is simple to operate and clean, and which provided relatively high-resolution and a wide range of mastitis infection information. A handheld mastitis sensor which could be implemented using relatively low-cost components and which employed a battery as a power source will also be of advantage.

### DISCLOSURE OF THE INVENTION

According to one aspect of the present invention there is provided a mastitis sensor which incudes
a testing chamber defining a receiving port,
a reagent reservoir, and
a manual reagent delivery assembly configured to deliver a controlled volume of liquid reagent to the testing chamber from the reagent reservoir,
a shuttle located within the testing chamber,
a shuttle contact transducer engaged with the testing chamber opposite to the receiving port,
a shuttle position reset assembly, and
an output indication assembly.

According to another aspect of the present invention there is provided a mastitis sensor which incudes
a testing chamber defining a receiving port,
a reagent reservoir containing a liquid reagent incorporating an anionic surfactant with a percentage concentration by weight of 10-50%, and
a reagent delivery assembly configured to deliver a controlled volume of liquid reagent to the testing chamber from the reagent reservoir,
a shuttle located within the testing chamber,
a shuttle contact transducer engaged with the testing chamber opposite to the receiving port,
a shuttle position reset assembly, and
an output indication assembly.

The present invention is adapted to provide a mastitis sensor. Preferably this mastitis sensor is implemented with a compact, self-contained and portable design, allowing it to be used on demand in a wide range of locations. For example, such an arrangement can find particular utility in dairy farming applications to easily obtain and immediately test a milk sample from an identified dairy animal.

Reference throughout this specification will in general be made to the invention being used to test milk samples sourced from dairy animals located at a milking facility such as a farm milking shed. In such applications the invention may be used to provide a prompt indication of mastitis to allow for the segregation of the milk produced by the infected animal and treatment actions to be taken in respect of this animal. Those skilled in the art will appreciate that the invention may be used in a wide variety of additional applications and need not necessarily be used to test the milk produced by dairy animals in commercial dairy focused applications.

In a preferred embodiment the mastitis sensor includes a housing which at least partially encloses, mounts or collects together the various other parts of the apparatus. Preferably this housing may be gripped and manoeuvred by a user employing one hand only. In a further preferred embodiment this housing may have a substantially elongate and preferably cylindrical form allowing it to be gripped and manoeuvred easily. In such embodiments this elongate housing may define a top and base end respectively, where preferably the housing is held upright to receive a milk sample to its top end. In various embodiments a cylindrical housing may be formed by a single curved side wall and a top element covering the top of the testing chamber.

Reference throughout this specification will also be made to the present invention employing or including an elongate cylindrical housing to enclose additional components of the mastitis sensor. Reference will also be made to the mastitis sensor in use being held in an upright orientation. However, those skilled in the art will appreciate that other shapes and configurations of housings may also be employed, as can other orientations which are also within the scope of the invention.

The mastitis sensor provided by the invention includes or defines a testing chamber. This testing chamber is arranged to receive and contain a sample of milk to be tested for the presence of a mastitis infection. Preferably the testing chamber used may exhibit a height. This testing chamber defines a receiving port which allows for the entry of a milk sample into the testing chamber, and also for the removal of fluid from within the testing chamber once a test procedure has been completed.

In various embodiments the invention may incorporate a plurality of receiving ports which allow for entry of a milk sample into the testing chamber. The exact arrangements or configuration of this collection of receiving ports may vary across different embodiments.

In one further preferred embodiment the invention may incorporate a central receiving port and one or more peripheral receiving ports. In these circumstances a central receiving port may be located near to the centre of the top of the housing, while peripheral receiving ports can be situated closer to the edge of the housing. The convenient positioning of the central receiving port may make it the closest receiving port to the highest lifted position of the shuttle.

This arrangement allows for easy flushing of the testing chamber in cleaning operations. A pressured source of cleaning fluid can be directed at a peripheral receiving port and exit the central receiving port or vice versa to flush the testing chamber.

Reference throughout this specification will be made to the invention including a plurality of receiving ports for the testing chamber-and in particular a central receiving port and one or more peripheral receiving ports as described above. Those skilled in the art will however appreciate that other configurations and arrangements of a single receiving port or a set of receiving ports are also within the scope of the invention.

In a preferred embodiment a testing chamber may be defined in one end of the housing and preferably in association with a defined upper end of the housing. In such embodiments a milk sample can be directed into this testing chamber under the action of gravity when the housing is held in an upright orientation. Preferably in this arrangement the receiving ports of the testing chamber will therefore be formed in the top of the testing chamber and adjacent to the upper end of the housing, allowing for the receipt of a milk sample and for the easy removal of fluids from the testing chamber after the completion of test procedures.

Reference throughout this specification will also be made to the invention incorporating a testing chamber in the upper portion of its housing. Again, those skilled in the art will appreciate that a testing chamber may not necessarily be located in this region of the housing and reference to the above should in no way be seen as limiting.

In a preferred embodiment a catch cup may be provided which projects from the top end of the housing to surround the receiving ports of the testing chamber. Preferably a catch cup may define a projecting angled wall extending at a lateral angle from the perimeter of the housing to channel a milk sample towards the testing chamber's receiving ports. In various embodiments this catch cup wall or walls may have a substantially curved form to aid in the collection of milk samples.

In a further preferred embodiment a sample retention baffle may be provided which projects from the top end of the housing. This baffle may define a projecting angled wall extending at a lateral angle from the perimeter of the housing to surround a receiving port of the testing chamber. In such embodiments the sample retention baffle extends around the receiving port and projects from the top of the housing inside the perimeter of the catch cup.

In further preferred embodiments this sample retention baffle may extend around and surround a central receiving port. In such embodiments the baffle will therefore operate only in conjunction with the central receiving port.

By surrounding the receiving port the baffle acts as an overflow cache when liquid reagent is delivered to the testing chamber and when the shuttle is lifted within the chamber. As the shuttle is lifted it has a mixing effect on the reagent and milk medium and its passage creates turbulence which could eject liquid from the central receiving port. In such embodiments milk exposed to and mixed with the reagent is caught in the baffle and returned to the testing chamber-preventing the loss of milk exposed to a high concentration of reagent.

The mastitis sensor provided by the invention includes a reagent reservoir. This reservoir can be used to contain and to provide liquid reagent to be mixed with milk samples received into the testing chamber. This reservoir can therefore be used as a supply of any form of appropriate reagent which increases the viscosity of a milk sample exhibiting a mastitis infection.

In a preferred embodiment the reagent reservoir may contain a reagent incorporating an anionic surfactant. For example, in various preferred embodiments the desired anionic surfactant can be provided by commonly available detergents such as Sodium Dodecyl Sulphate (SDS) Sodium Lauryl Sulphate (SLS), or similar compounds.

In a preferred embodiment a reagent reservoir may have a modular or removable attachment to a housing provided for the sensor. This modular characteristic can allow an empty or exhausted reservoir to be swapped out and replaced as required.

In some embodiments the reagent reservoir may define the base of the assembly, with the reservoir being releasable engaged with the housing. For example in some embodiments the reservoir may be used form the base of the mastitis sensor and can be screwed, clipped or otherwise removably connected into a housing or an intermediary component. In such embodiments the housing can form at least the sidewalls of the sensor while the reservoir forms the base.

Preferably the reagent is a concentrated gelling agent with a composition providing an anionic surfactant with a 10-50% percentage concentration by weight of an anionic surfactant. In a further preferred embodiment the reagent used by the invention may have provide an anionic surfactant with a percentage concentration by weight of 20-30%.

Preferably the reagent reservoir is used to contain and supply a reagent which is undiluted and as concentrated as possible. The use of a concentrated undiluted gelling reagent has significant advantages when the effects of ambient temperature are considered on the measurements made by the invention. Milk samples obtained immediately from a dairy animal are at body temperature while reagent is normally provided at ambient environment temperature. The gelling or viscosity characteristic considered by the invention is highly dependent on the temperature of the resulting reagent and milk mixture, so having a concentrated reagent of the lowest volume possible keeps the mixture an overall higher temperature than that would be experienced with a larger volume diluted reagent. This is a particularly useful characteristic of the invention when used in locations with relatively low environmental temperatures.

In addition, a concentrated reagent acts to increase the resulting sensitivity of the mastitis sensor. As the reagent used does not need to undergo a preliminary dilution step using water, the milk sample employed is the only source of additional liquid. This can result in substantial increases in viscosity when mastitis infected milk is tested and can also allow for the accurate measurement of low-level mastitis infections.

The mastitis sensor provided by the invention includes a shuttle located within the testing chamber. This shuttle moves within the testing chamber during execution of a test procedure. The test procedure relies on the introduction of a controlled volume of liquid reagent into the test chamber once a milk sample has also been received into the test chamber via its receiving port. At the start of a test procedure the shuttle can be initially positioned in the upper end of the testing chamber, preferably adjacent to the receiving port. During the test procedure the shuttle can be allowed to fall under the action of gravity through a milk and reagent mixture, with the shuttle's transit or fall time being recorded. As the reagent used induces a gelling effect in milk subject to mastitis infection, the increased viscosity of the milk reagent mixture will slow the fall of the shuttle, with measured transit times being used to calculate the degree of mastitis infection.

In some preferred embodiments the width of the testing chamber may be at least equal to the maximum width or diameter of the shuttle but less than twice the maximum width or diameter of the shuttle. In such embodiments the shuttle may preferably fall from the top to the bottom of the testing chamber without risk of impacting its sidewalls and creating a source of error in the measurements being recorded.

In a preferred embodiment the shuttle may include a magnet insert component which allows for contactless manoeuvring or movement of the shuttle by an applied magnetic field. In further preferred embodiments this magnetic insert may be positioned or offset from the geometric middle or centre point of the shuttle. In such embodiments this magnetic insert may be denser than that of the other material used to form the shuttle, resulting in a predictable shuttle orientation as it transits the testing chamber during a testing procedure.

Preferably a shuttle provided in accordance with the present invention may have a substantially spherical shape or form. A sphere does not extend any projections, minimising chances of the shuttle slowing its fall by knocking against the side walls of the testing chamber during testing procedures. In addition, a spherical shuttle is less likely to become stuck to the base or bottom of the testing chamber by a viscous reagent/milk mixture.

Reference throughout this specification will also be made to the mastitis sensor incorporating a shuttle with a spherical form or shape. However, those skilled in the art will also appreciate that other arrangements of and different types of shuttles may also be utilised in conjunction with the invention.

In a preferred embodiment the diameter or span of this spherical shuttle may be greater than the extent or diameter of the testing chamber's receiving port or ports. This arrangement therefore ensures that the shuttle is trapped inside the testing chamber and cannot escape it even if the housing is inverted and gravity urges the shuttle into a receiving port. In other additional embodiments the receiving port may incorporate or defined an array of projections or nodules extending into the testing chamber which can interfere with and engage with a shuttle to prevent it from blocking a receiving port.

Preferably the receiving ports allow for removal of milk and reagent mixtures after the completion of a testing procedure. The limited diameter of the receiving ports compared to that of the shuttle allows a clearance process to be undertaken simply by inverting, shaking or flicking the housing to remove milk/reagent mixtures once no longer required. Furthermore, in various embodiments a flushing liquid such as tap water may also be introduced through a receiving port to clean and clear the testing chamber, with the housing then being inverted and shaken again to clear this flushing liquid and ready the apparatus for further use.

The mastitis sensor provided by the invention also includes a shuttle position reset and release assembly. This assembly is used to position and hold the shuttle in the upper region of the testing chamber adjacent to the central receiving port prior to the start of a testing procedure.

The position reset assembly may also be used to complete a mixing operation for reagent introduced into the testing chamber containing a fresh milk sample. In these circumstances the housing of the apparatus will be held on upright orientation to retain the fresh milk sample within the testing chamber and prevent it from leaking out of the associated receiving port. The action of gravity will locate the shuttle at the bottom of the testing chamber, with the position reset assembly being used to move the shuttle through the milk and reagent mixture to the top of the testing chamber. The motion of the shuttle through these liquids will therefore engender a mixing effect, preferably resulting in an increase in the viscosity the mixture when mastitis infected milk is present.

Furthermore, as indicated above a shuttle with a spherical shape may be utilised in some preferred embodiments. The spherical shuttle provided engenders less turbulence during upward mixing movements, minimising the chances of the shuttle breaking up a gel forming in the testing chamber and interfering with the viscosity increase relied on by the invention.

In a preferred embodiment a shuttle position reset assembly may be formed using coils of wire energised to implement an electromagnet. The magnetic field generated by the energised coils can interact with a magnetic insert integrated into the shuttle to attract and lift the shuttle from the bottom of the testing chamber and move it to a position adjacent to the receiving port in the upper region of the testing chamber. Maintaining this magnetic field will hold the shuttle in a fixed position and ready for the execution of a testing procedure. A testing procedure can then be triggered by disabling this magnetic field, allowing the shuttle to fall to the bottom of the testing chamber through the mixed milk and reagent with the fall time of the shuttle being recorded.

In a further preferred embodiment a shuttle position and reset assembly may be formed by a stacked array of two or more wire coils energised in a timed sequence. This array exhibits improved energy efficiency, with an electromagnetic field only being generated in close proximity to the shuttle as it moves through the lifting coil stack to a test starting position.

Reference throughout this specification will be made to a shuttle position and reset assembly being formed by an array of lifting coils. However those skilled in the art will appreciate that other mechanisms could potentially fulfil the role of this element of the invention and references made to lifting coils should in no way be seen as limiting

The mastitis sensor provided by the invention includes a manual reagent delivery assembly. This assembly is configured to deliver a controlled volume of liquid reagent to the test chamber from the reagent reservoir. This assembly may have a manual character, relying on a force or action executed by the user of the invention to provide the energy to drive a controlled volume of liquid reagent through from the reservoir into the testing chamber.

In various embodiments the operation of a manual reagent delivery assembly may result in an overflow of excess milk being free to exit the testing chamber through the receiving port. The manual reagent delivery assembly may preferably supply a fixed dose of reagent to the bottom of the testing chamber in a controlled fashion which in turn displaces an equivalent volume of milk from preferably the top of the testing chamber.

In a preferred embodiment the reagent delivery assembly can be configured to direct or inject liquid reagent towards the centre of the testing chamber. The delivery assembly can incorporate a nozzle or barrel used to control the trajectory of the reagent that it delivers, and in further preferred forms may inject reagent into the interior of an array of lifting coils deployed at the centre of the lifting chamber.

In a preferred embodiment of a manual reagent delivery assembly may incorporate a piston or plunger and cylinder arrangement, with the cylinder holding a fixed volume of reagent prior to the plunger entering the cylinder and driving this liquid into the testing chamber. In such embodiments the delivery assembly may define a trigger lever or projection element which is free to move a fixed distance when pressed or moved by a user. This trigger can be linked to the plunger and used to apply a force of plunger to drive it through and into the associated cylinder.

Furthermore, the return stroke of the plunger moving out of the cylinder can also be used to draw a fresh volume of reagent into the delivery assembly. In such embodiments a compression spring or other similar return element may be engaged with the user operable lever to urge this component back to its normal staring position. A one-way valve assembly may also be integrated into the outlet of the cylinder to prevent milk from the testing chamber being drawn into the delivery assembly cylinder. A further valve may be provided suppling a connection between the cylinder and the reagent reservoir allowing fresh reagent to be drawn from the reagent reservoir once the plunger is drawn back to its start position outside of the chamber.

Reference throughout this specification will also be made to the present invention employing a plunger and cylinder arrangement in the implementation of a manual reagent delivery assembly. Those skilled in the art will however appreciate that other manual delivery systems may also be utilised in conjunction with the present invention—such as for example, squeeze bulbs or similar components—and reference to the above should in no way be seen as limiting.

The mastitis sensor provided by the invention includes a shuttle contact transducer engaged with the testing chamber opposite to the receiving ports. A shuttle contact transducer is arranged to provide a signal generated by the termination of the fall of the shuttle, either through contact with the base or floor of the testing chamber, or through contact with the transducer itself. In various embodiments this transducer may be sensitive to sound or vibrations. In particular the transducer may provide a signal caused by the contact made by the shuttle at the end of its fall.

In preferred embodiments this contact transducer may preferably be located, connected to or otherwise associated with the exterior surface of base or floor of the testing chamber when the housing is position in an upright orientation. This will therefore locate the contact transducer adjacent to the terminal point of the fall of the shuttle during testing procedures. By engaging the contact transducer with the exterior of the testing chamber floor sound or vibrations generated by the shuttle striking or contacting the chamber floor will be transmitted through to its exterior and the associated contact transducer.

However, those skilled will appreciate that in other embodiments a contact transducer may be located inside the testing chamber. In such embodiments the transducer can be mounted to engage with the floor of the testing chamber within the interior of the testing chamber. In such embodiments the invention may be arranged so that a falling shuttle contacts or strikes the transducer at the end of its travel through the testing chamber.

In yet another embodiment, a contact transducer can also act as the floor of the testing chamber. In such embodiments the testing chamber would have an open bottom end. The contact transducer would be placed over the bottom opening and sealed around the edges. In this way a falling shuttle would contact or strike the transducer directly.

Reference throughout this specification will however be made to a shuttle contact transducer being engaged with the exterior surface of the base of testing chamber. Those skilled in the art will appreciate that other arrangements are also within the scope of the invention.

In a preferred embodiment the shuttle contact transducer may include a piezo electric element configured to generate a contact signal when the base of the testing chamber is struck by the shuttle. Such piezo electric signals are relatively noise free, providing a high impulse, short duration and low noise signal which can be used to identify the completion time of the shuttle's fall through the testing chamber. The signal provided by this transducer also has a predictable and relatively easy to interpret response over a wide range of relative viscosity values for reagent milk mixtures. This characteristic ensures that the mastitis sensor provided is able to measure and detect relatively low levels of mastitis infections through to measuring the extent of high-intensity infections.

In a preferred embodiment the lifting coils are immersed in sample liquid introduced into the testing chamber. In further preferred embodiments the metal wires of the lifting coils may be over moulded by a covering material which is preferably formed from an easily cleaned electrically insulator. This form of the invention allows the central volume surrounded by the stack of lifting coils to define a channel through which the shuttle moves up and down. Therefore the immersion of the lifting coils places their magnetic fields immediately adjacent to the shuttle, providing for a compact, energy efficient implementation of the invention.

In a preferred embodiment the housing may be provided with a two part releasable form, with a top of the housing being removable from the side wall(s). In a further preferred embodiment the coil or coils of the shuttle position assembly may be connected to the top of the housing and can therefore be removed from the interior of the testing chamber for cleaning operations. In such embodiments a user may be given access to the interior of the testing chamber and also to the lifting coils to thoroughly clean these components when required.

In a preferred embodiment the lifting coils engage with contact switch connectors deployed within the interior of the testing chamber. Contact switches rely on a separate element physically contacting the switch to trigger the flow of electrical current. For example, in various embodiments a contact switch may be provided by a spring loaded contact plate which enables an electrical connection only after the plate has been depressed by the contact pin of a shuttle lifting coil. An electrical connection will be made and current will be supply to the lifting coil contact provided the lifting coil's contact depresses the contact plate a certain distance against the action of a return spring. The provision of these contact switches allow the lifting coils to be easily engaged and disengaged with an electrical energy supply provided by the sensor assembly.

Preferably contact switches may be defined on the base of the testing chamber, allowing the coils of the shuttle position assembly to be easily lifted in and out of the testing chamber for cleaning operations.

A mastitis sensor provided in accordance the present invention also includes an output indication assembly. This indication assembly may be used to communicate information to the user of the invention, preferably to indicate the extent of any mastitis infection detected within a received milk sample. Those skilled in the art will appreciate that this output indication assembly may be implemented many different ways depending on the particular application in which the invention is used and the associated requirements of its users.

For example, in one embodiment an array of indicator lights and/or an LCD screen may be mounted to the exterior surface of a housing provided for the sensor. The number of lights energised, pattern of lights energised, or position energised rights can indicate the extent of any mastitis infection detected, or may be utilised to indicate the operational status, readiness or condition of the mastitis sensor itself. Similarly, an LCD screen can be used to indicate text or numerical in information indicating extent of mastitis infection or the operational state of the mastitis sensor. In yet other embodiments an output indication assembly may be composed from or incorporate a communications interface. Such an interface can allow for the transmission of testing procedure results to a connected computer system, smart phone, or other forms of programmable computing devices.

In various preferred embodiments the mastitis sensor provided may also include a microprocessor or other equipment form of programmable control system. A microprocessor may be used to manage the operation of the mastitis sensor, from controlling the operation of the shuttle position reset assembly to mix reagent and milk samples, release the shuttle to fall through the mixed milk and reagent, receive signals from the shuttle contact transducer, and determine a fall-time based on these received signals for a specific testing procedure. Furthermore, such a processor may also apply a calibration procedure to the received or calculated fall-time and provide an indication of the extent of mastitis infection and communicate this information to the output indication assembly.

In a preferred embodiment a processor utilised in conjunction with the present invention may also execute a low current low energy consumption sleep mode. In this mode the processor may perform a minimum set of operations to conserve power and then be put into a low-power sleep mode. The processor may be woken to full operational capacity after a fixed delay period or by an electrical switch. In a further preferred embodiment operation of the manual reagent delivery assembly can also operate a switch which is used to trigger the waking of the processor to full operational capacity.

In a preferred embodiment the mastitis sensor may include an electrical battery assembly to power the various electrical components. For example, a battery may be integrated into the invention to provide it with a portable character, allowing use wherever required. In these embodiments the invention may also incorporate and associated battery charging circuit and coils, allowing the battery to be recharged without needing to access the interior of the housing.

The present invention may provide many potential advantages over the prior art.

In various embodiments the invention may provide a small, portable, simple, and easy to use mastitis sensor. The compact nature of the invention allows it to be manoeuvred and used in restricted spaces and also provide it with a rugged and robust character. The sensor may provide accurate and relatively high-resolution measurements of the extent of mastitis infections experienced by dairy animals or in other species if desired.

Such measurements may also extend over a large range, providing accurate information on both low-level and high-level infections. In various embodiments improvements facilitated through the concentration and form of the reagent used, and in the form of the shuttle contact transducer may singularly or in combination provide such sensitivity improvements.

In various embodiments the invention may be implemented with a small number of moving parts, substantially reducing the electrical power consumption required in its operation. The reagent required within the testing chamber can be delivered manually, while in various embodiments a microprocessor capable of a low power consumption operational mode may also be utilised. This allows for the use of a compact battery system which is capable of operating the invention effectively, thereby providing it with a flexible, portable character.

Furthermore, the configuration and arrangement of the invention also allows for manual clearance and optional flushing of the testing chamber after use. Again, this aspect of the design and operation of the invention eliminates the need for further electrical energy consuming components, while also simplifying maintenance tasks which need to be completed for the sensor to operate effectively over time.

### BRIEF DESCRIPTION OF THE DRAWINGS

Additional and further aspects of the present invention will be apparent to the reader from the following description of embodiments, given in by way of example only, with reference to the accompanying drawings in which:

FIG. 1 provides a perspective view of a mastitis sensor as provided in accordance with one embodiment of the invention,

FIG. 2 provides a front view of the mastitis sensor shown with respect to FIG. 1,

FIG. 3 shows a rear view of the mastitis sensor shown with respect to FIGS. 1 and 2,

FIG. 4 shows a top view of the mastitis sensor illustrated with respect to FIGS. 1 through 3,

FIG. 5 shows a side cross-section view of the sensor provided in accordance with FIGS. 1 through 4, and

FIG. 6 shows a cross-section schematic view of the top the mastitis sensor provided in accordance with the embodiment of FIGS. 1 through 5,

FIG. 7 shows the two part form of the sensor provided in relation to FIGS. 1 to 6, and

FIG. 8 shows a cross section view of elements of a sensor assembly provided in an alternative embodiment to that of FIGS. 1 through 7.

Further aspects of the invention will become apparent from the following description of the invention which is given by way of example only of particular embodiments.

### BEST MODES FOR CARRYING OUT THE INVENTION

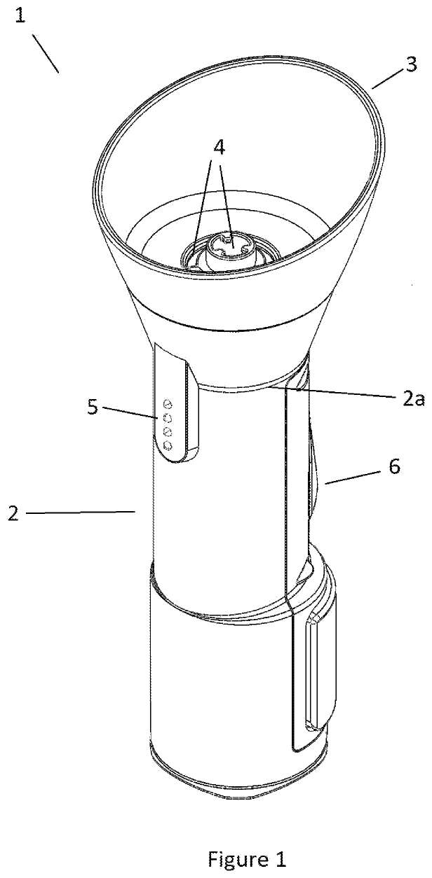

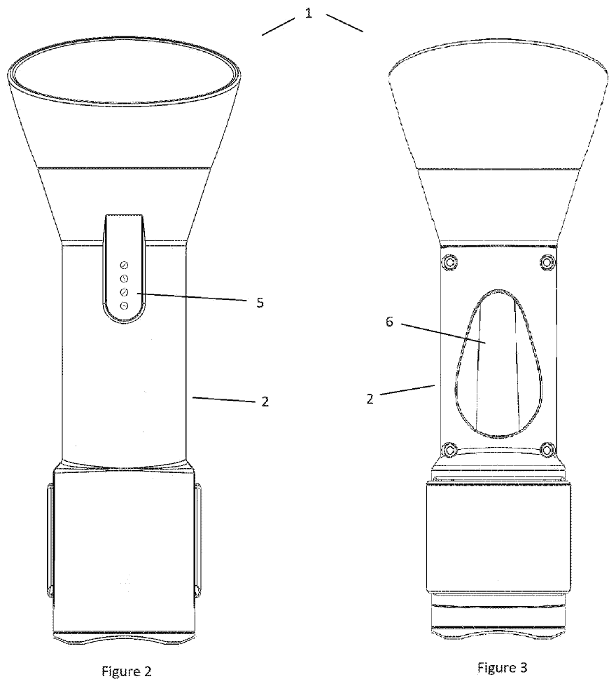

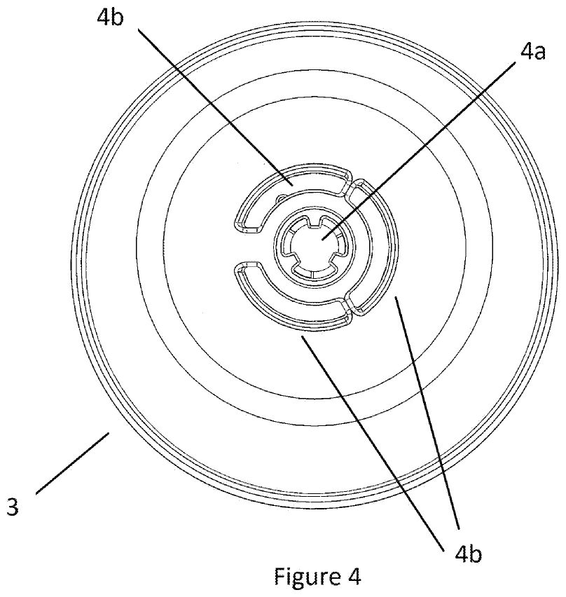

FIGS. 1 through 7 show a number of views of a mastitis sensor 1 as provided in accordance with embodiment of the invention.

FIGS. 1 through 4 provide a number of external views of the sensor 1, predominantly illustrating the provision of an elongate cylindrical housing 2 which has a catch cup structure 3 extending from the upper end 2a of the housing. The catch cup 3 increases the area within which a milk sample can be collected from. The cup's curved shape and profile guide milk towards and into a series of receiving ports 4 which gives access to the interior of the sensor. The top view provided by FIG. 4 in particular shows the provision of a central receiving port 4a and an array of peripheral receiving ports 4b located further out towards the edge of the housing.

FIGS. 1-4 also show elements of an output indicator, illustrated in this embodiment by an array of projecting LEDs lights 5. The activation of these lights provides a user of the sensor an indication of the results obtained from test procedures completed by the sensor. In the embodiment shown these lights also indicate the operational readiness state of the sensor, such as for example, if it is experiencing a low battery condition, if the sensor is currently ready to execute testing procedure, or if it is being orientated incorrectly for a testing procedure.

FIGS. 1-4 also show a trigger lever 6 which forms part of a manual reagent delivery system. A user depressing this trigger lever provides the force required to operate this manual reagent delivery system.

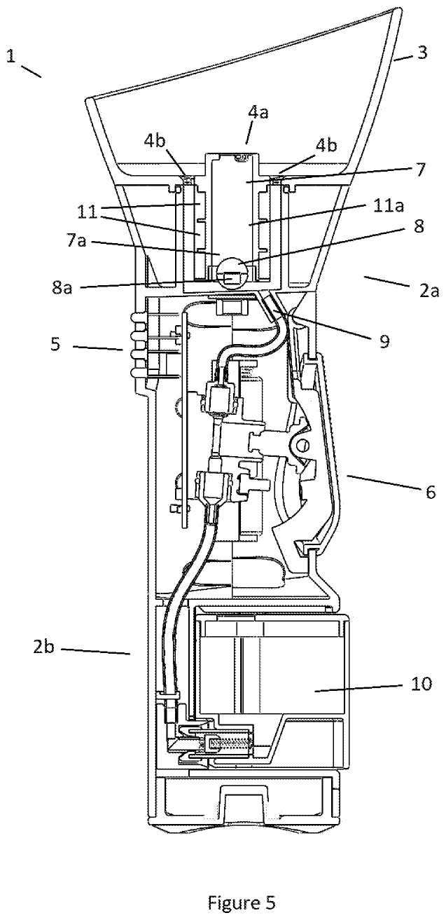

As can be seen from the cross section view of FIG. 5 the upper region 2a defines a testing chamber 7 used to locate and retain a shuttle 8. The bottom region 7a of the testing chamber is engaged with the output stage of a manual reagent delivery system 9 which in turn is connected to and supplied with reagent by a reagent reservoir 10 located in the base or bottom region of the housing.

A microprocessor (not shown) is connected to the output indicator LEDs 5 and configured to energise these lights appropriately to indicate the results obtained by testing procedures executed by the sensor.

The shuttle has a spherical form and incorporates a magnetic insert 8a, allowing the shuttle to be lifted from the bottom of the testing chamber when the electromagnetic coils 11 of the shuttle position reset assembly are energised by a command signal from the processor. As can be seen from these figures this magnetic insert 8a is offset from the geometric centre point of the shuttle.

The energised coils will lift the shuttle up to the top of the testing chamber and hold it in place adjacent to the central receiving port 4a to ready the sensor 1 for the execution of a test procedure. This lifting operation also executes a mixing effect on a milk sample combined with a measured volume of reagent supplied to the testing chamber through the operation of the manual reagent delivery system 9.

When the mastitis sensor is ready for use it is orientated in the upright position shown with respect to FIG. 5, and a milk sample is collected in the catch cup 3 and delivered through the receiving ports 4 into the testing chamber 7. The shuttle 8 rests on the base 7a of the testing chamber under the action of gravity.

A user then activates the reagent delivery system by depressing the trigger lever 6, applying a force to a drive plunger which sweeps out a fixed volume of a reagent containing cylinder, injecting reagent into the base of the testing chamber. One way check valves are also provided to ensure that when the trigger lever returns to its original position under the action of a return spring, the vacuum force applied by the withdrawal of the plunger from the cylinder acts to pull a further charge of reagent out of the reagent reservoir.

The lifting coils 11 of the shuttle position reset assembly are then activated to draw the shuttle 8 up through the testing chamber 7, thereby mixing the injected reagent with the milk sample. This action lifts the shuttle away from a piezoelectric contact transducer 12 mounted to the exterior surface of the base 7a of the testing chamber.

A testing procedure can be completed at this stage by disabling the electrical current supplied to the shuttle position coils 11, marking the start of a fall-time period which is terminated on receipt of a contact signal from a piezoelectric contact transducer at the base of the testing chamber. As can be seen from FIG. 5 the width or diameter of the lifting coils central cavity 11a which the shuttle moves through is larger than that of the shuttle, reducing the chances of the shuttle knocking against the coils as it falls.

The microprocessor then calculates shuttle fall-time from when the positioning coils are deactivated through to the receipt time of the signal from the contact transducer. An indication of the degree of mastitis infection present in the milk sample is calculated by the processor using a calibration process and the determined shuttle fall time. This information is communicated to the user by the processor lighting up an increasing number of the LED lights 5 of the output indication assembly.

To ready the sensor for a new testing procedure the housing simply needs to be inverted and agitated to expel the used milk sample and reagent mixture from the testing chamber. If available a flushing liquid such as water may also be introduced through any of the receiving ports to clean out the testing chamber, with this flushing liquid again being expelled by inversion of the housing.

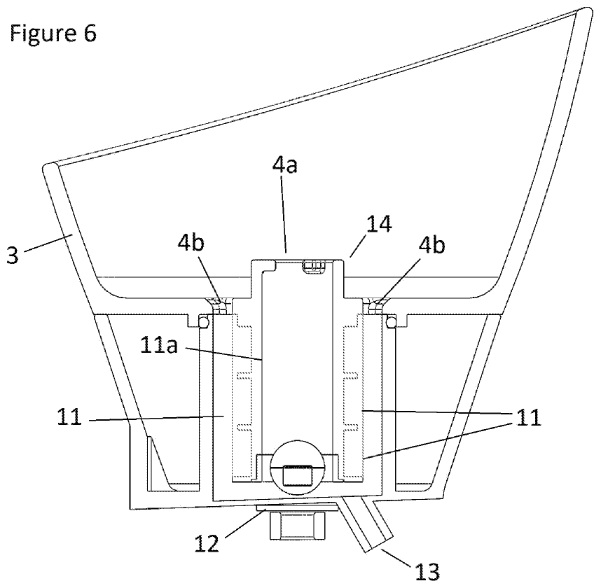

FIG. 6 shows a cross-section schematic view of the top a mastitis sensor provided in accordance with the embodiment of FIGS. 1 through 5. This view shows the shuttle position reset and release assembly formed by a vertically stacked array of lifting coils 11, with each indentation in the stack marking the boundary between adjacent coils. In particular the cross-section view of FIG. 6 illustrates how the timed sequential energising of each of these coils 11 can act to lifts a spherical shuttle 8 from the base of a testing chamber 7 up to the top of the chamber and a central receiving port 4a.

This vertical stack of lifting coils also defines an enclosing channel 11a for the shuttle, allowing a reagent delivery nozzle 13 to inject reagent directly into this channel. The mixing process is completed by raising the shuttle to the central receiving port 4a to ensure milk within the central channel is exposed to high concentrations of liquid reagent.

FIG. 6 also illustrates the provision of a sample retention baffle 14 which extends around the perimeter of the central receiving port 4a and inside the perimeter of an outer catch cup wall 3. This can be contrasted with the peripheral receiving ports 4b which can supply liquid into the periphery of the testing chamber. When reagent is injected into the testing chamber this baffle 14 stores overflowing milk and reagent mixture. Turbulence caused by lifting of the shuttle is also prevented from injecting liquid from the test chamber as the buffer acts to return this liquid.

The provision of a piezo electric shuttle contact transducer 12 is also shown by FIG. 6, with this transducer being mounted to the exterior of the base of the testing chamber. The contact made between the shuttle and the interior of the testing chamber base during testing procedures can therefore be detected using this component.

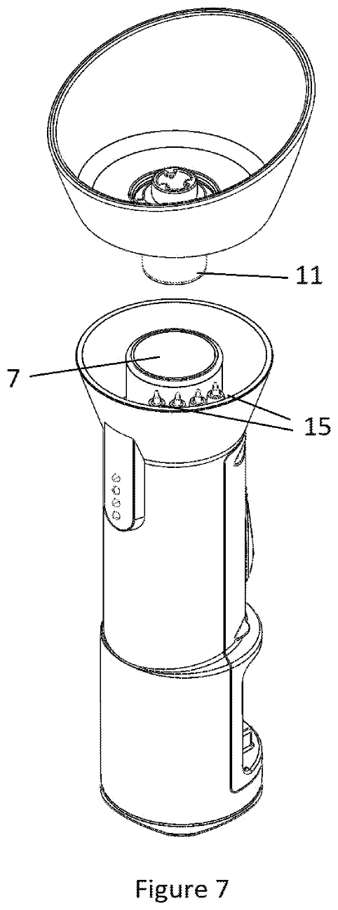

FIG. 7 shows the two part form of the sensor provided in relation to FIGS. 1 to 6. As can be seen from this figure the top of the sensor may be removed from connection with the cylindrical housing side wall 2, removing the stack of lifting coils 11 from the interior of the testing chamber 7. This feature allows for deep cleaning of the testing chamber as well as the lifting coils once separated from one another.

FIG. 7 also shows the provision of a series of contact switch connectors 15 deployed in the upper region of the housing. These contacts switches allow the lifting coils to be dropped back down into the testing chamber with physical contact between coil terminals (not shown) and the contact switches allowing electrical energy to be supplied to the coils.

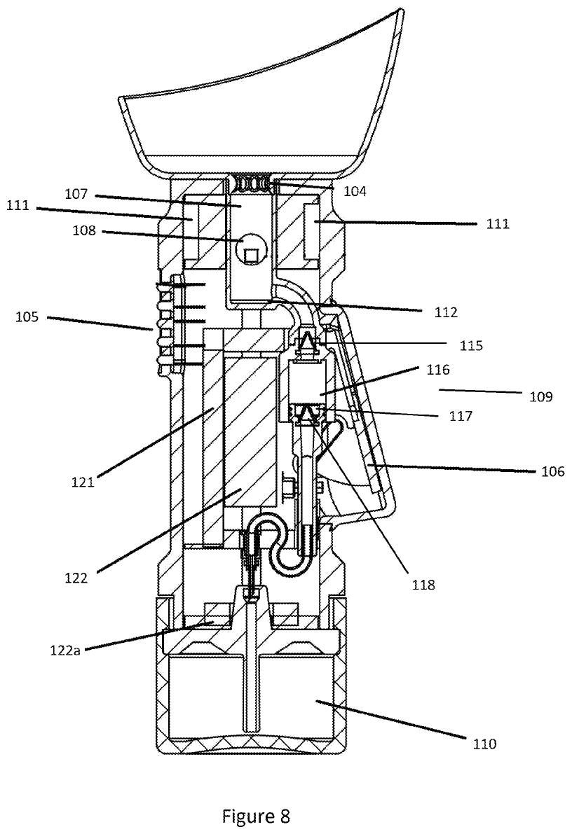

FIG. 8 shows a cross section view of elements of a sensor assembly provided in an alternative embodiment to that of FIGS. 1 through 7. The elements of the sensor shown are similar in respect to the embodiment of FIGS. 1 through 7. The assembly shown includes a single receiving port 104, testing chamber 107, spherical shuttle 108, shuttle position reset and release lifting coil 111, output LED lights 105 and a piezo electric shuttle contact transducer 112. FIG. 8 also illustrates the provision of a controlling microprocessor 121 connected to a battery pack 122 and charging coils circuit 122a.

As can also be seen from FIG. 8 a manual reagent delivery system 109 is arranged to receive liquid reagent from the reagent reservoir 110. A further connection allows for the delivery of a controlled volume of this liquid reagent to the testing chamber 107.

The manual reagent delivery system 109 incorporates an upper one-way valve 115 preventing liquids from travelling from the testing chamber 107 through to a fixed volume reagent cylinder 116. The bottom end of the reagent cylinder 116 is closed by a drive plunger 117 where the head of the plunger also incorporates a lower one-way valve 118.

In the configuration shown in FIG. 8 the reagent cylinder 116 is filled with liquid reagent. Depression of a trigger lever 106 forces the drive plunger 117 upwards through the reagent cylinder 116 while maintaining lower one-way valve 118 in a closed arrangement. Once the drive plunger 117 has reached the top of the reagent cylinder a fixed volume of liquid reagent has been transmitted through to the testing chamber 107.

The subsequent release of the trigger lever 106 allows a return spring (not shown) to pull the drive plunger back down, with the vacuum force generated opening the lower one-way valve 118 and drawing a replacement controlled volume of liquid reagent into the reagent cylinder.

In the preceding description and the following claims the word “comprise” or equivalent variations thereof is used in an inclusive sense to specify the presence of the stated feature or features. This term does not preclude the presence or addition of further features in various embodiments.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

1. A mastitis sensor which incudes
a testing chamber defining a receiving port,
a reagent reservoir, and
a manual reagent delivery assembly configured to deliver a controlled volume of liquid reagent to the testing chamber from the reagent reservoir,
a shuttle located within the testing chamber,
a shuttle contact transducer engaged with the testing chamber opposite to the receiving port,
a shuttle position reset assembly, and
an output indication assembly.

2. The mastitis sensor as claimed in claim 1 which includes a cylindrical housing with a catch cup projecting from the top of the housing to surround the receiving port of the testing chamber.

3. The mastitis sensor as claimed in claim 2 which includes a sample retention baffle extending around the receiving port and projecting from the top of the housing inside the perimeter of the catch cup.

4. The mastitis sensor as claimed in claim 1 wherein the liquid reagent is a concentrated gelling agent with a 10-50% percentage concentration by weight of an anionic surfactant.

5. The mastitis sensor as claimed in claim 4 wherein the liquid reagent is a concentrated gelling agent with a 20-30% percentage concentration by weight of an anionic surfactant.

6. The mastitis sensor as claimed in claim 1 wherein the manual reagent delivery assembly incorporates a plunger engaged with a cylinder configured to hold a fixed volume of liquid reagent.

7. The mastitis sensor as claimed in claim 1, wherein the contact transducer is sensitive to vibrations.

8. The mastitis sensor as claimed in claim 1, wherein the contact transducer is located on the exterior surface of the base of the testing chamber.

9. The mastitis sensor as claimed in claim 7, wherein the shuttle contact transducer includes a piezo electric element.

10. The mastitis sensor as claimed in claim 1 wherein the shuttle includes a magnet insert component located offset from the centre point of the shuttle.

11. The mastitis sensor as claimed in claim 1 wherein the shuttle has a spherical shape.

12. The mastitis sensor as claimed in claim 1 wherein the shuttle position reset and release assembly positions and hold the shuttle in the upper region of the testing chamber adjacent to the receiving port prior to the start of a testing procedure.

13. The mastitis sensor as claimed in claim 12 wherein the shuttle position reset assembly is formed using at least one coil of wire energised to implement an electromagnet.

14. The mastitis sensor as claimed in claim 13 wherein the shuttle position reset assembly is formed by an array of two or more wire coils energised in a timed sequence.

15. The mastitis sensor as claimed in claim 13 wherein the wire coil or coils of the shuttle position reset assembly are located within the interior of the testing chamber and are immersed in milk samples supplied to the interior of the testing chamber.

16. The mastitis sensor as claimed in claim 2 wherein the housing is provided with a two part releasable form, with the top of the housing being removable from the side wall or walls of the housing.

17. The mastitis sensor as claimed in claim 13, wherein the housing is provided with a two part releasable form, with the top of the housing being removable from the side wall or walls of the housing, and wherein the coil or coils of the shuttle position assembly are connected to the top of the housing and are removable from the interior of the testing chamber.

18. The mastitis sensor as claimed in claim 1 wherein the manual reagent delivery assembly is configured to direct liquid reagent towards the centre of the testing chamber and into the centre of the coil or coils of the shuttle position reset assembly.

19. A mastitis sensor which incudes
a testing chamber defining a receiving port,
a reagent reservoir containing a liquid reagent incorporating an anionic surfactant with a percentage concentration by weight of 10-50%, and
a reagent delivery assembly configured to deliver a controlled volume of liquid reagent to the testing chamber from the reagent reservoir,
a shuttle located within the testing chamber,
a shuttle contact transducer engaged with the testing chamber opposite to the receiving port,
a shuttle position reset assembly, and
an output indication assembly.
